(19) United States
(12) Patent Application Publication
(10) Pub. No.: US 2023/0171846 A1
(43) Pub. Date: Jun. 1, 2023

(54) LICENSED WIRELESS IN-VEHICLE NETWORK ACCESS BASED ON EMERGENCY NETWORK ACCESS CONTROL

(71) Applicants: Hong CHENG, San Diego, CA (US); Shailesh PATIL, San Diego, CA (US); Dan VASSILOVSKI, San Diego, CA (US); Gene Wesley MARSH, San Diego, CA (US); Lan YU, San Diego, CA (US); QUALCOMM Incorporated, San Diego, CA (US)

(72) Inventors: Hong CHENG, Basking Ridge, NJ (US); Shailesh PATIL, San Diego, CA (US); Dan VASSILOVSKI, Del Mar, CA (US); Gene Wesley MARSH, San Diego, CA (US); Lan YU, Beijing (CN)

(21) Appl. No.: 17/919,977

(22) PCT Filed: May 29, 2020
(86) PCT No.: PCT/CN2020/093241

§ 371 Date: Oct. 19, 2022

(51) Int. Cl. H04W 76/50; H04W 76/10; H04W 4/90

(52) U.S. Cl. CPC H04W 76/50; H04W 76/10; H04W 4/90; H04W 4/44

(57) ABSTRACT

Certain aspects of the present disclosure provide techniques for licensed wireless in-vehicle network access based on emergency network access control. A method that may be performed by a user equipment (UE) generally includes detecting a trigger event for an emergency network access procedure. The method also includes, in response to detecting the trigger event, transmitting a first message to a base station, the first message comprising a request to use one or more licensed bands for communication via a wireless in-vehicle network (wIVN). The method also includes receiving a second message from the base station, the second message granting the use of the one or more licensed bands for communication via the wIVN.

### BACKGROUND

### Field of the Disclosure

Aspects of the present disclosure relate to wireless communications, and more particularly, to techniques for licensed wireless in-vehicle network access based on emergency network access control.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

As the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved emergency network access procedure and control via a wireless in-vehicle network using licensed bands.

Certain aspects of the subject matter described in this disclosure can be implemented in a method for wireless communication by a user equipment (UE). The method generally includes detecting a trigger event for an emergency network access procedure. The method also includes, in response to detecting the trigger event, transmitting a first message to a base station, the first message comprising a request to use one or more licensed bands for communication via a wireless in-vehicle network (wIVN). The method also includes receiving a second message from the base station, the second message granting the use of the one or more licensed bands for communication via the wIVN.

Certain aspects of the subject matter described in this disclosure can be implemented in a method for wireless communication by a base station. The method generally includes receiving a first message from a first UE, the first message comprising a request to use one or more licensed bands for communication via a wireless in-vehicle network (wIVN). The method also includes transmitting a second message to the first UE, the second message granting the use of the one or more licensed bands for communication via the wIVN.

Certain aspects of the subject matter described in this disclosure can be implemented in a method for wireless communication by a sensor of a vehicle. The method generally includes receiving a first message from a UE, the first message comprising instructions to communicate with the UE via a wireless in-vehicle network (wIVN) using one or more licensed bands. The method also includes transmitting information related to the vehicle to the UE via the wIVN using the one or more licensed bands.

Certain aspects of the subject matter described in this disclosure can be implemented in a method of wireless communication by a user equipment (UE). The method generally includes transmitting a first message to one or more sensors of a vehicle, the first message instructing the one or more sensors to communicate with the UE via a wireless in-vehicle network (wIVN) using one or more licensed bands. The method also includes receiving, on the one or more licensed bands via the wIVN, a second message from a first sensor of the one or more sensors, the second message comprising information related to the vehicle. The method also includes transmitting the received information to a public safety answering point (PSAP).

Aspects of the present disclosure provide means for, apparatus, processors, and computer-readable mediums for performing the methods described herein.

Aspects of the present disclosure provide means for, apparatus, processors, and computer-readable mediums for performing techniques and methods that may be complementary to the operations by the UE described herein, for example, by a BS.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 is a call flow diagram illustrating example operations of an emergency network access, in accordance with certain aspects of the present disclosure.

FIG. 5 is a flow diagram illustrating example operations for wireless communication by a UE, in accordance with certain aspects of the present disclosure.

FIG. 6 is a flow diagram illustrating example operations for wireless communication by a BS, in accordance with certain aspects of the present disclosure.

FIG. 7 is a flow diagram illustrating example operations for wireless communication by a sensor of a vehicle with a UE, in accordance with certain aspects of the present disclosure.

FIG. 8 is a flow diagram illustrating example of operations for wireless communication by a UE with a sensor of a vehicle, in accordance with certain aspects of the present disclosure.

FIG. 9 illustrates a communications device that may include various components configured to perform operations for the techniques disclosed herein in accordance with aspects of the present disclosure.

FIG. 10 illustrates a communications device that may include various components configured to perform operations for the techniques disclosed herein in accordance with aspects of the present disclosure.

FIG. 11 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for using wireless in-vehicle network access using licensed bands during an emergency network access procedure. Though certain aspects are discussed with respect to wireless in-vehicle network access, such aspects may, during an emergency network access procedure, be used for other wireless device network access using licensed bands and/or for other access procedures.

In certain aspects, for accidents involving a vehicle, certain regulations may require transmitting a minimum set of data (MSD) via an emergency network access (e.g., an eCall) procedure to a public safety answering point (PSAP). Examples of PSAPs may include, but are not limited to, call centers where emergency calls, such as emergency calls for police, fire department, and/or an ambulance, are received. MSD may include certain information related to the vehicle, such as vehicle type information, vehicle identification number (VIN), fuel/propulsion type, current location of the vehicle, one or more previous locations of the vehicle, estimated number of occupants of the vehicle, and/or the like.

The MSD may be transmitted to the PSAP by a communication device (e.g., a modem) that is communicatively coupled to one or more sensors of the vehicle. Examples of the sensors may include, but are not limited to, vehicle seat sensors, vehicle body sensors, a global positioning system of the vehicle, an engine control unit of the vehicle, and/or other units of the vehicle configured to capture, measure, and/or transmit information related to the vehicle. Some of the MSD may include information from the one or more sensors of the vehicle. Examples of such information may include, but not limited to, fuel/propulsion type, current location of the vehicle, one or more previous locations of the vehicle, vehicle direction, estimated number of occupants of the vehicle, and the like. The information from the sensors may be transmitted to the communication device via a wired in-vehicle network (IVN).

However, when the vehicle is in an accident, the communication lines of the IVN connecting the one or more sensors to the communication device may be damaged and the information related to the vehicle from the sensors may not be transmitted to the communication device, and the communication device may not successfully provide the MSD to a PSAP via an emergency network access procedure. This may result in delays in dispatching the needed help (e.g., a first responder) by the PSAP.

Accordingly, certain aspects of the present disclosure provide various techniques for, such as when the vehicle is in an accident, successfully transmitting data related to the MSD from the one or more sensors of the vehicle to a communicatively coupled communication device, and transmitting the MSD from the communication device to the PSAP. In certain aspects, techniques for successfully transmitting data related to the MSD from the one or more sensors of the vehicle to a communicatively coupled communication device may be based on configuring the one or more sensors to communicate with the communication device via a wireless in-vehicle network (wIVN) using one or more licensed bands when the vehicle is involved in an accident. The one or more licensed bands may be mobile spectrum bands that are part of the licensed spectrum allocated to a mobile network operator. Using the licensed bands in transmitting information related to the MSD from the one or more sensors of the vehicle to the communication device via the wIVN may also reduce interference in transmitting the data while also satisfying various reliability requirements for transmitting MSD related information from the sensors to the communication device. In certain aspects, based on certain regulations, when an emergency network access procedure (e.g. eCall) is initiated, all other communications within the vehicle are disabled. In certain aspects, when the wIVN is configured to be operated using licensed bands, it can be configured to operate using one or more licensed bands that do not interfere with the emergency network access, and could be exempted from the rule. In a wIVN the sensors may directly communicate wirelessly with the communication device and/or other sensors, such as without requiring communication via a base station.

The following description provides examples of licensed wireless in-vehicle network access based on emergency network access control in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

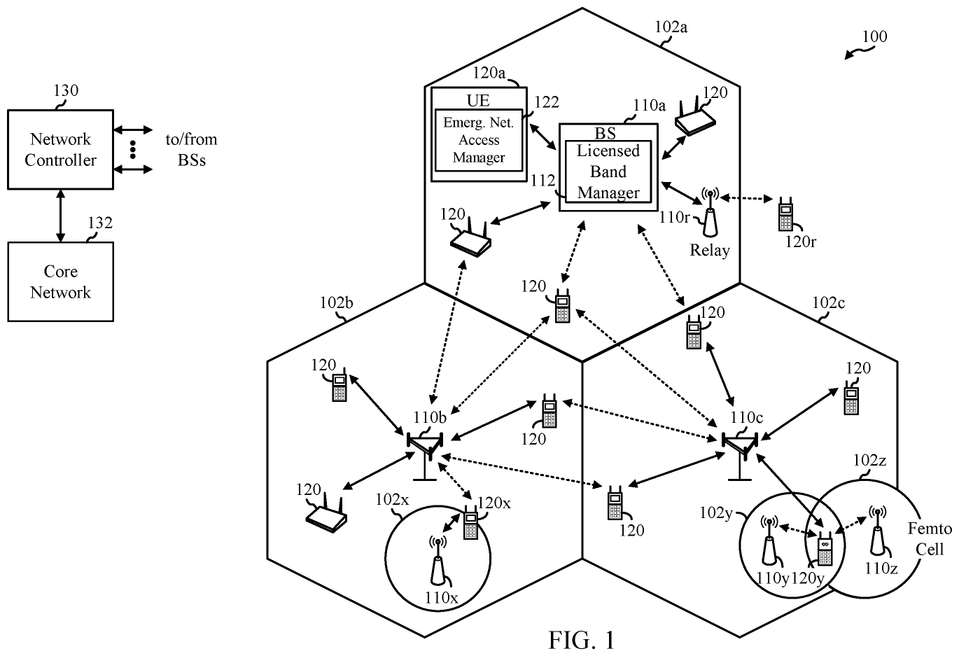

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

According to certain aspects, the BSs 110 and UEs 120 may be configured for transmitting data including, but not limited to, system information, MSD, and/or the like. As shown in FIG. 1, the BS 110a includes licensed band manager 112 that may be configured to grant and/or authorize requests for access to licensed bands, in accordance with aspects of the present disclosure. The UE 120a includes a an emergency network access manager 122 that may be configured to request access to licensed bands for use in a wIVN and transmit MSD to PSAP in accordance with aspects of the present disclosure.

In certain aspects, the UE 120a may be configured to communicate with one or more sensors of a vehicle via wIVN. In certain aspects, when a trigger for emergency network access (e.g., eCall) is not detected, the UE 120a and the one or more sensors of the vehicle may communicate directly with each other. For example, when a trigger for emergency network access is not detected, the UE 120a and the one or more sensors of the vehicle may communicate directly with each other via wIVN using Bluetooth, WiFi Direct, and other direct communication technologies, and bands of the unlicensed spectrum without requiring communication via a BS 110. In certain aspects, however, based on regulation, when the emergency network access procedure is initiated, such communication over the unlicensed spectrum may not be allowed.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

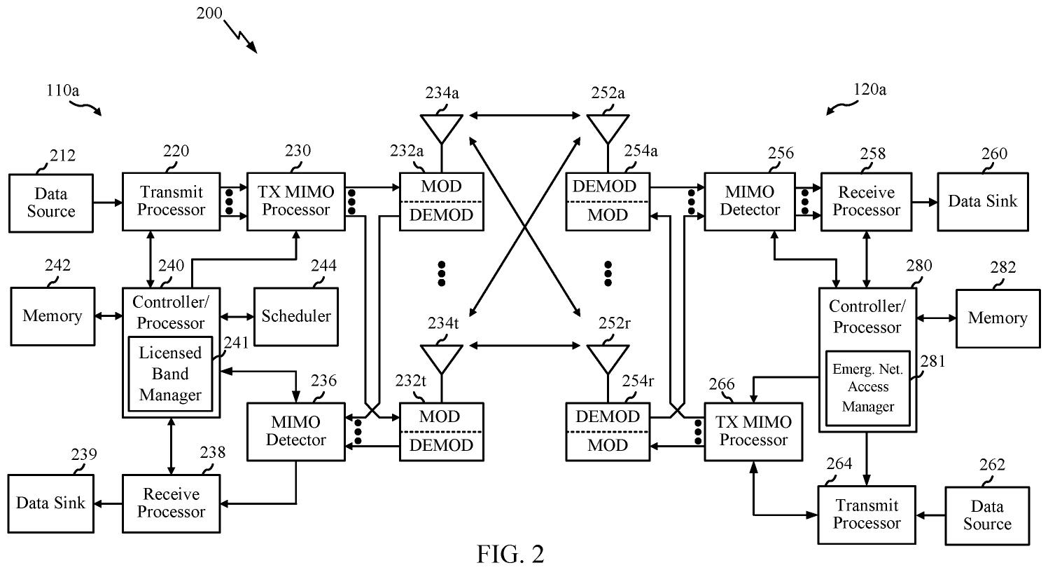

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PS SCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a licensed band manager 241 that may be configured to grant and/or authorize requests for access to licensed bands, according to aspects described herein. As shown in FIG. 2, the controller/processor 280 of the UE 120a has an emergency network access manager 281 that may be configured to request access to licensed bands for use in a wIVN and transmit MSD to PSAP , according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

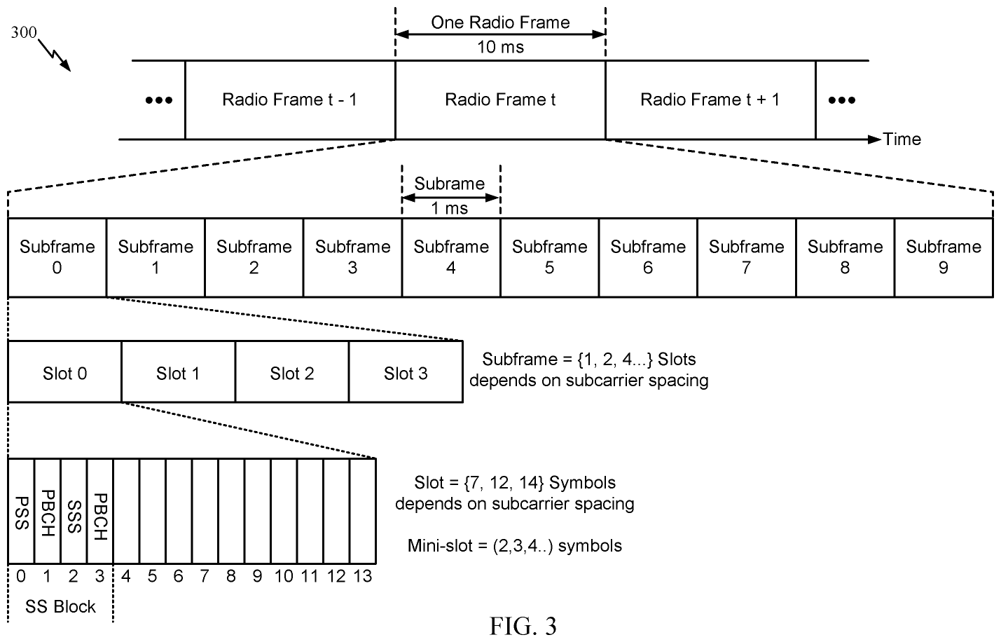

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

As described above, when a vehicle is involved in an accident, certain regulations may require transmitting a minimum set of data (MSD) via an emergency network access (e.g., an eCall) procedure to a public safety answering point (PSAP). The MSD may be transmitted by a communication device (e.g., UE 120a) which may be communicatively coupled to one or more sensors of the vehicle and the PSAP. Some of the MSD may include information captured, measured, analyzed, and/or recorded by the one or more sensors of the vehicle, and which is transmitted to the communication device from the one or more sensors via the IVN and/or wIVN. The communication device may be communicatively coupled to the one or more sensors via a wired in-vehicle network (IVN) and/or a wireless in-vehicle network (wIVN). As described above, the communication device and the one or more sensors of the vehicle may be configured to communicate directly with each other via the wIVN using direct communication technologies such as Bluetooth, WiFi Direct, and other similar direct communication technologies.

When the communication device and the one or more sensors are communicatively coupled with each other via an IVN, the communication links (e.g., wires) of the IVN communicatively coupling the one or more sensors with the communication device may be damaged during the accident, and the information from the one or more sensors may not transmitted to the communication device. Similarly, when the communication device and the one or more sensors are communicatively coupled with each other via wIVN, as described above, the information from the sensors to the communication device may not be reliably transmitted via wIVN due to interference from other devices in the vehicle that may also use unlicensed spectrum to communicate with each other and/or the communication device. Additionally, in certain aspects, such communication over unlicensed spectrum may not be allowed when the emergency network access procedure is initiated in certain regions. Thus, such wireless transmission of information from the one or more sensors to the communication device may not meet some of the reliability requirements of the regulations requiring transmission of the MSD to the PSAP.

Accordingly, what is needed are techniques and apparatus for transmitting certain MSD related information from one or more sensors of the vehicle to a communication device, such that the transmission satisfies reliability and performance requirements of regulations.

### Example Licensed Wireless in-Vehicle Network Access Based on Emergency Network Access Control

Aspects of the present disclosure provide communication between one or more sensors of the vehicle and a communication device via a wIVN using one or more licensed bands.

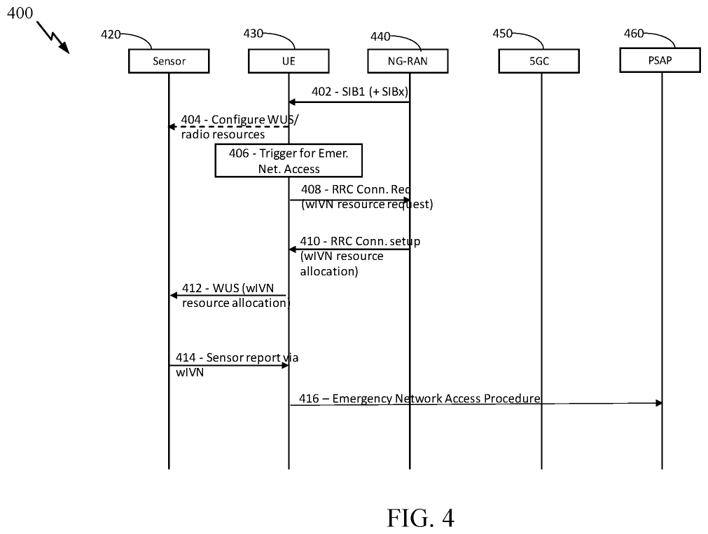

FIG. 4 illustrates a call flow diagram illustrating example operations for transmitting MSD when a trigger for an emergency network access event is detected. The figure shows transactions between one or more sensors 420 of a vehicle, a UE 430, NG-RAN 440, a core network 450, and a PSAP 460. In the example shown in FIG. 4, the UE 430 may be similarly configured as UE 120a described above with reference to FIGS. 1, 2, and 3. In certain aspects, the NG-RAN 440 may be similarly configured as BS 110a as described above with reference to FIGS. 1, 2, and 3. In certain aspects, the NG-RAN 440 may be a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, etc.). The NG-RAN 440 may communicate with UE 430 on downlink channels (e.g., for transmissions from a base station or to a UE) and uplink channels (e.g., for transmissions from a UE to a base station or distributed unit).

As described above, examples of the sensors 420 may include, but are not limited to, vehicle seat sensors, vehicle body sensors, a global positioning system of the vehicle, an engine control unit of the vehicle, and/or other units of the vehicle configured to capture, measure, analyze, and/or transmit information related to the vehicle.

In the example FIG. 4, the UE 430 is connected to the NG-RAN 440. At 402, the NG-RAN 440 transmits information to the UE 430 that indicates whether the mobile network supports an emergency network access (e.g., eCall). The NG-RAN 440 may transmit such information in a system information block (SIB). For example, NG-RAN 440 may indicate that the network supports an emergency network access via a bit or flag in the system information block 1 (SIB1). In certain aspects, the NG-RAN 440 may transmit information related to whether the network allows for licensed bands to be used for communication in a wIVN, a range of licensed bands that can be used for communicating via the wIVN, other corresponding radio resources, and/or configuration of other operational parameters (e.g., a discontinuous reception (DRX) cycle, a schedule period for using licensed bands, and/or the like). For example, the NG-RAN 440 may transmit information indicating whether the network allows for licensed bands to be used in a wIVN in another SIB or via another bit in SIB 1. Similarly, the NG-RAN 440 may transmit information related to the range of licensed bands that can be used for communication in a wIVN, other radio resources, and/or configuration of other operational parameters for the emergency network access.

At 404, the UE 430 transmits a message comprising configuration information to the one or more sensors 420 of the vehicle. In certain aspects, the UE 430 may transmit a set of wake-up signal (WUS) messages, to configure and/or cause the sensors 420 to use wIVN for reporting and/or providing information to the UE 430. In certain aspects, each WUS message may comprise and/or correspond to a set of configuration information. In certain aspects, the UE 430 configures the sensors 420 to receive the set of WUS messages, at certain time periods. In certain aspects, the configuration information may include, but is not limited to, the range of licensed bands that the sensors 420 may use to communicate with the UE 430 via the wIVN, schedule period for using the licensed bands, DRX cycle, and/or the like. The UE 430 may transmit the message comprising the configuration information to the one or more sensors 420 via an IVN or a wIVN. In certain aspects, when transmitting the configuration information to one or more sensors 420 via wIVN, the UE 430 may be configured to transmit the configuration information to the one or more sensors 420 using a direct communication technology such as Bluetooth, WiFi Direct, and/or the like, without requiring communication via a base station (e.g., NG-RAN 440). In certain aspects, when transmitting the configuration information at 404, the UE 430 may be configured to utilize communication resources without interfering with communications between other units and/or devices of the vehicle to enable normal operation of the vehicle. For example, the UE 430 may wait until sufficient communication resources are available and/or until other higher prioritized tasks are completed before transmitting the configuration information to the one or more sensors 420.

In certain aspects, the configuration information may be homogenous across a Tracking Area (TA) and/or a public land mobile network (PLMN). Thus, in certain aspects, the configuration information of the one or more sensors 420 may not have to be updated frequently. In certain aspects, the UE 430 and the one or more sensors 420 may be preconfigured with various emergency network access configurations to configure the operational parameters for using the licensed bands via the wIVN. Based on the location of the vehicle, the one or more sensors 420 and the UE 430 may be configured to use one of the preconfigured emergency network access configurations for communication via the wIVN using the licensed bands.

At 406, the UE 430 may detect a trigger event for an emergency network access. As described above, the trigger event for an emergency network access may be the vehicle being involved in an accident. At 408, the UE 430 transmits a message to the NG-RAN 440 requesting use of one or more licensed bands for communication with the one or more sensors via the wIVN. The message may indicate the one or more licensed bands and other configuration information of the radio resources that may be used by the wIVN. Examples of configuration information of the radio resources include, but are not limited to, time resources, frequency resources, a mode of operation, a period of time for the operation to complete, and/or the like. Examples of a mode of operation may include, but are not limited to, wIVN network management, data exchange on the wIVN (e.g., transmitting information from the one or more sensors 420 to the UE 430), and/or the like.

In certain aspects, the one or more licensed bands indicated in the request by the UE 430 may be based on the range of licensed bands and other configuration information indicated in the one or more SIB s received from the NG-RAN 440. In certain aspects, the one or more licensed bands indicated in the request by the UE 430 may be based on the range of licensed bands and other configuration information indicated in a predetermined emergency network access configuration selected by the UE 430 based on location of the vehicle. In certain aspects, if the UE 430 is in idle mode, the transmitted message by the UE 430 to the NG-RAN 440 may be a radio resource control (RRC) connection request message. In certain aspects, if the UE 430 is in connected mode, the transmitted message by the UE 430 to the NG-RAN 440 may be a dedicated RRC message (e.g., a sidelink UE information (SLUEinfo) message, UE assistance information message, and/or the like).

At 410, the NG-RAN 440 grants the authorization of the use of the requested licensed bands and the corresponding radio resources for communication between the UE 430 and the one or more sensors 420 via the wIVN. The NG-RAN 440 may be configured to determine a time duration for the licensed bands to be used for communication via the wIVN based on a status, a mode, and/or information of the UE. For example, if the UE is already in the connected mode, and/or if the NG-RAN 440 already has the UE 430's contextual information (e.g., whether the UE 430 is authorized, an identification number of the UE 430, and/or the like), then the NG-RAN 440 may determine that the UE 430 satisfies a certain trust level and grants a longer duration of time to use the licensed bands and/or other radio resources for communication via the wIVN than if the UE 430's mode is idle and/or if the NG-RAN 440 does not have contextual information of the UE 430.

At 412, the UE 430 may transmit a message to the one or more sensors 420 instructing the one or more sensors to communicate with the UE 430 via wIVN using one or more licensed bands indicated in the message. In certain aspects, the message may be a wake-up signal (WUS) message. In certain aspects, the one or more sensors 420 may be configured to receive and/or poll for WUS messages periodically at a predetermined time interval. In certain aspects, the UE 430 may be configured to set the time interval as part of the configuration information transmitted to the one or more sensors 420 at 404.

Returning to 412, in certain aspects, the message transmitted by the UE 430 to the one or more sensors 420 may indicate one or more licensed bands and corresponding resources authorized by the NG-RAN 440 for communication via the wIVN. In certain aspects, the message transmitted by the UE 430 to the one or more sensors 420 may indicate a configuration index value, and the one or more sensors 420 may be configured to select the corresponding emergency network access configuration based on the configuration index value in the message.

At 414, the one or more sensors 420 transmit the information related to the vehicle such as, fuel/propulsion type of the vehicle, current location of the vehicle, one or more previous locations of the vehicle, vehicle direction, and/or estimated number of occupants of the vehicle, to the UE 430 via wIVN using the one or more licensed bands and the configuration of the radio resources as indicated in the message from the UE 430 at 412. At 416, the UE 430 completes the emergency network access procedure by transmitting the MSD information, which includes the information received from the sensors 420, to the PSAP 460. In certain aspects, the UE 430 may establish an IP Multimedia Subsystem (IMS) call session with the PSAP 460, via the NG-RAN 440 and the core network 450, and the UE 430 may transmit the MSD to the PSAP 460 by embedding the MSD in the IMS call session setup procedure.

In certain aspects, the NG-RAN 440 may be configured to store vehicle identity information, and/or the UE 430 identity information at 408, and may attach and/or append that data to charging record data for the mobile network operator's use. In certain aspects, the charging record data may include the vehicle identity information, the UE 430 identity information, and the one or more licensed bands to which access was granted. The NG-RAN 440 may be configured to transmit the charging records to the mobile network operator to enable the mobile network operator to charge the user of the UE 430 and/or the user of the vehicle for using the licensed bands. In certain aspects, the mobile NG-RAN 440 may embed an indicator in the call setup to the PSAP that the licensed bands and other radio resources granted for the wIVN are being used and that the additional corresponding charges can be applied to the user of the vehicle and/or the UE 430. In certain aspects, the mobile network operator may provide the charging records to an entity (e.g., governmental entity, a regulatory body, and the like), as proof of compliance with the regulation, or receive additional spectrum as a reward, and the like.

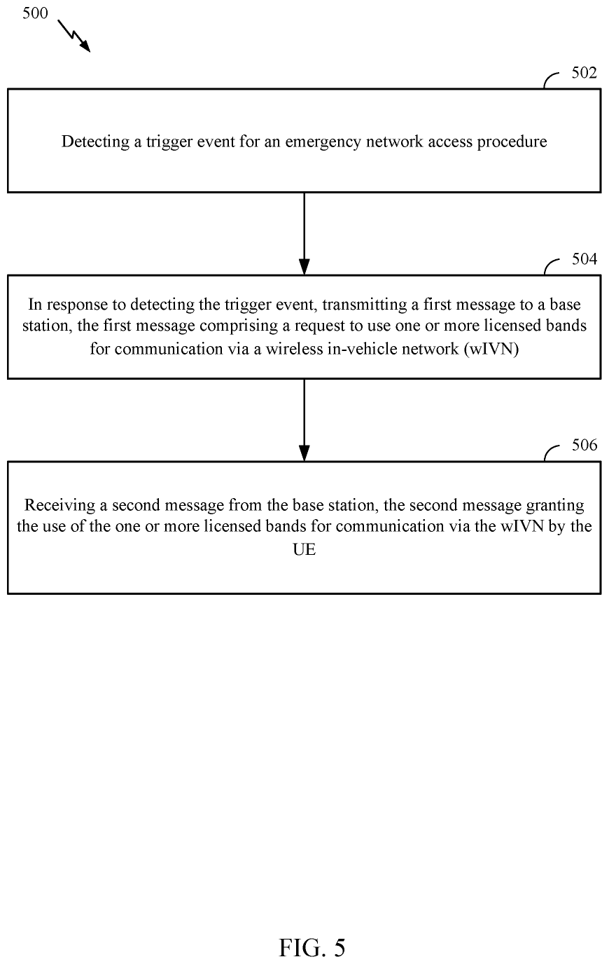

FIG. 5 is a flow diagram illustrating example operations 500 for wireless communication, in accordance with certain aspects of the present disclosure. The operations 500 may be performed, for example, by UE (e.g., the UE 120a in the wireless communication network 100). The operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 500 may begin, at 502, where the UE (e.g., UE 120a) detects (e.g., via emergency network access manager 122) a trigger event for an emergency network access (e.g., eCall) procedure. At 504, the UE, in response to detecting the trigger event, transmits a first message to a base station (e.g., BS 110a), the first message comprising a request to use one or more licensed bands for communication via a wireless in-vehicle network (wIVN). At 506, the UE receives a second message from the base station, the second message granting the use of the one or more licensed bands for communication via the wIVN.

In certain aspects, as described above, the one or more licensed bands, to which the UE requests access, are indicated in a SIB from the base station. In certain aspects, as described above, the one or more licensed bands, to which the UE requests access, are predetermined and indicated in one or more predetermined emergency network access configurations. In certain aspects, the first message is a radio resource control (RRC) connection request message when the UE is in idle mode. In certain aspects, the first message is a dedicated radio resource control (RRC) message when the UE is in connected mode. In certain aspects, the dedicated RRC message is a sidelink UE information (SLUEinfo) message.

In certain aspects, the UE, in response to receiving the second message, transmits a wake up signaling (WUS) message to one or more sensors (e.g., sensors 420), the WUS message instructing the one or more sensors to communicate with the UE via the wIVN using the one or more licensed bands. In certain aspects, the WUS message indicates a configuration of a set of radio resources for communication with the UE. In certain aspects, the UE receives, on the one or more licensed bands via the wIVN, one or more messages from the one or more sensors, the one or more messages comprising information related to the vehicle.

In certain aspects, the UE transmits, the received information to a public safety answering point (PSAP). In certain aspects, the UE transmitting the received information comprises transmitting a Minimum Set of Data (MSD) related to the vehicle. In certain aspects, the information related to the vehicle comprises one or more of: a type of the vehicle, an identifier of the vehicle, a propulsion type of the vehicle, a location of the vehicle, a direction of the vehicle, or a number of occupants of the vehicle. In certain aspects, the trigger event is an accident involving the vehicle. In certain aspects, the UE is a vehicle and the trigger event is an accident involving the UE.

In certain aspects, the UE receives a system information block (SIB) message from the base station, the SIB message indicating support for the emergency network access procedure by the base station. In certain aspects, the SIB message or a companion SIB message received by the UE from the base station indicates a configuration of a set of radio resources for communication via the wIVN. In certain aspects, the UE configures one or more sensors to communicate with the UE via the wIVN using the one or more licensed bands based on the SIB message. In certain aspects, the UE configures the one or more sensors via the wIVN. In certain aspects, the UE configures the one or more sensors via one or more wired connections (e.g., via IVN).

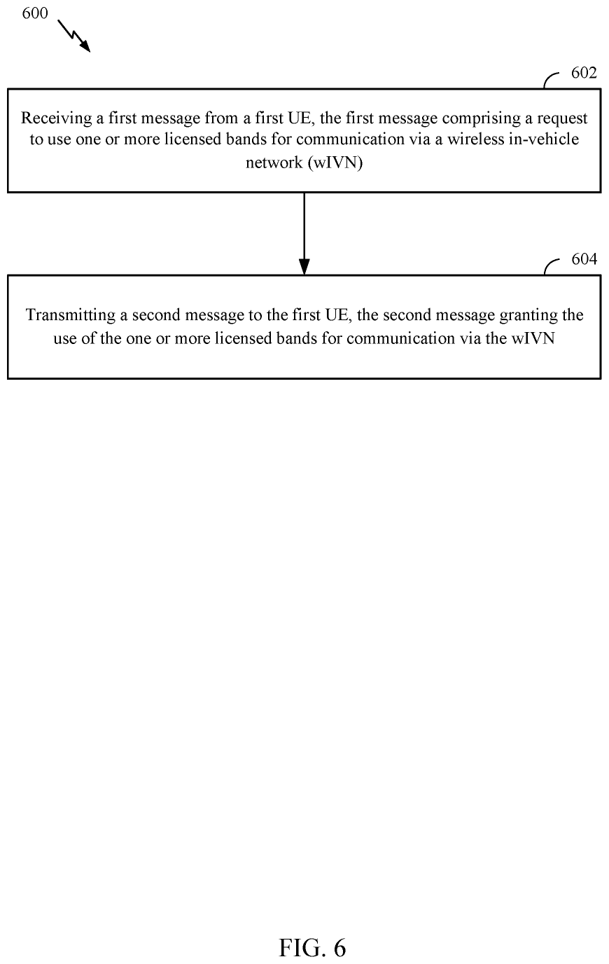

FIG. 6 is a flow diagram illustrating example operations 600 for wireless communication, in accordance with certain aspects of the present disclosure. The operations 600 may be performed, for example, by a BS (e.g., the BS 110a in the wireless communication network 100). The operations 600 may be complimentary to the operations 500 performed by the UE. The operations 600 may be implemented as software components that are executed and run on one or more processors (e.g., controller/processor 240 of FIG. 2). Further, the transmission and reception of signals by the BS in operations 600 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 600 may begin, at 602, where the base station (e.g., BS 110a) receives a first message from a first UE (e.g., UE 120a), the first message comprising a request to use one or more licensed bands for communication via a wireless in-vehicle network (wIVN) of the first UE. At 604, the base station (e.g., BS 110a), transmits a second message to the first UE, the second message granting the use of the one or more licensed bands for communication via the wIVN.

In certain aspects, the base station determines (e.g., via licensed band manager 112), based on a mode of the first UE, a time duration to use the one or more licensed bands, and the base station authorizes the use of the one or more licensed bands for the determined time duration by the first UE. In certain aspects, the time duration is greater when the mode of the first UE is connected than when the mode of the first UE is idle. In certain aspects, the second message indicates a set of radio resources for communication by the first UE via the wIVN.

In certain aspects, the base station generates (e.g., via licensed band manager 112), based on an identity of the first UE, a record indicating the use of the one or more licensed bands by the first. In certain aspects, transmitting the record to a network operator. In certain aspects, the first message is a radio resource control (RRC) connection request message when the UE is in idle mode. In certain aspects, the first message is a dedicated radio resource control (RRC) message when the UE is in connected mode. In certain aspects, the dedicated RRC message is a sidelink UE information (SLUEinfo) message. In certain aspects, the base station transmits a system information block (SIB) message to the first UE, the SIB message indicating support for an emergency network access procedure by the base station. In certain aspects, the SIB message or a companion SIB message transmitted by the base station indicates a configuration of a set of radio resources for communication via the wIVN by the first UE.

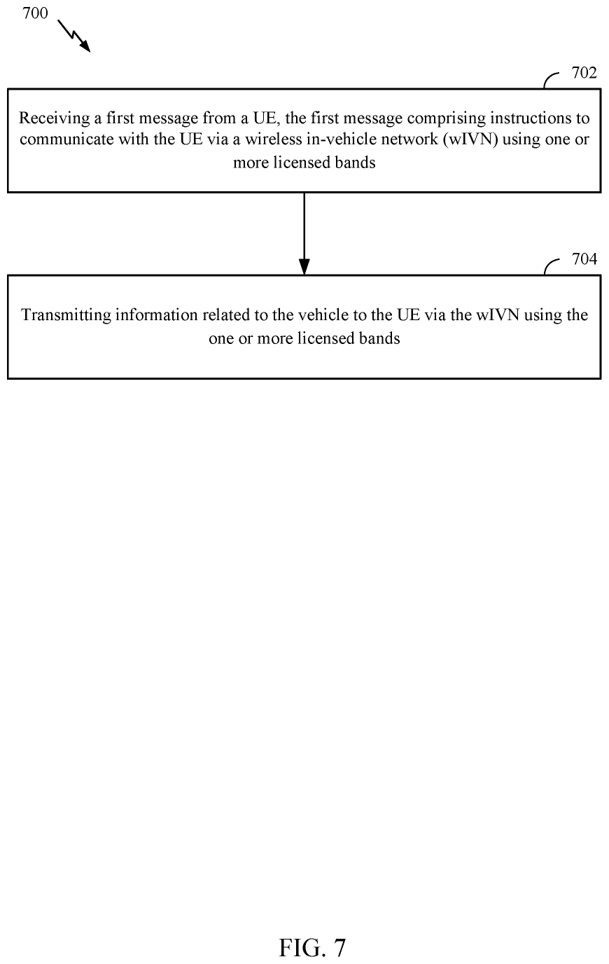

FIG. 7 is a flow diagram illustrating example operations 700 for wireless communication, in accordance with certain aspects of the present disclosure. The operations 700 may be performed, for example, by a sensor (e.g., sensor 420) of a vehicle. The operations 700 may be implemented as software components that are executed and run on one or more processors. Further, the transmission and reception of signals by the sensor in operations 700 may be enabled, for example, by one or more antennas. In certain aspects, the transmission and/or reception of signals by the sensor may be implemented via a bus interface of one or more processors obtaining and/or outputting signals.

The operations 700 may begin, at 702, where the sensor (e.g., sensor 420), receives a first message from a UE, the first message comprising instructions to communicate with the UE via a wireless in-vehicle network (wIVN) using one or more licensed bands. At 704, the sensor transmits information related to the vehicle to the UE via the wIVN using the one or more licensed bands.

In certain aspects, the information related to the vehicle comprises at least one of a current location, a previous location, vehicle direction, or estimated number of occupants. In certain aspects, the first message is a wake up signaling (WUS) message. In certain aspects, the first message indicates a set of radio resources to use in communication with the communication device via the wIVN. In certain aspects, the first message indicates a configuration index value corresponding to a predetermined emergency network access configuration of the sensor.

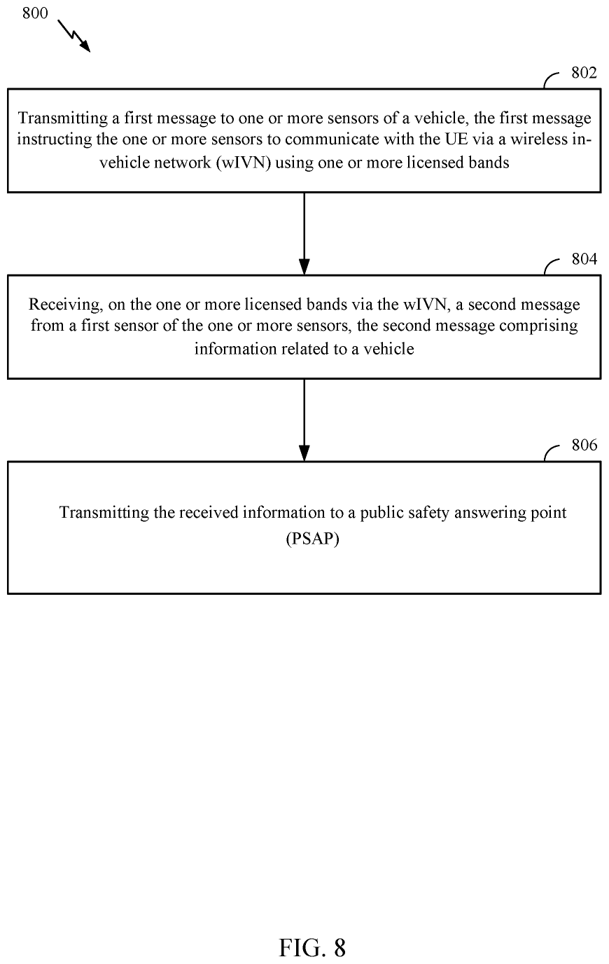

FIG. 8 is a flow diagram illustrating example operations 800 for wireless communication, in accordance with certain aspects of the present disclosure. The operations 800 may be performed, for example, by UE (e.g., the UE 120a in the wireless communication network 100). The operations 800 may be complimentary to the operations 700 performed by the sensor. The operations 800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 800 may begin, at 802, where the UE (e.g., UE 120a) transmits a first message to one or more sensors of the UE, the first message instructing the one or more sensors to communicate with the UE via a wireless in-vehicle network (wIVN) using one or more licensed bands. At 804, the UE receives, on the one or more licensed bands via the wIVN, a second message from a first sensor of the one or more sensors, the second message comprising information related to a vehicle. At 806, the UE transmits the received information to a public safety answering point (PSAP).

In certain aspects, the UE receives a system information block (SIB) message from a base station (e.g., BS 110a), the SIB message comprising a configuration of a set of radio resources for communication via the wIVN, and the UE causes the one or more sensors to reconfigure based on the received configuration of the set of radio resources.

In certain aspects, the UE transmits a third message to a base station, the third message comprising, based on the received configuration of the set of radio resources, a request to use the one or more licensed bands for communication via the wIVN. In certain aspects, the UE receives authorization from the base station to use the one or more licensed bands and allocation of the set of resources for communication via the wIVN. In certain aspects, the UE, in response to receiving the authorization, transmits the first message to the one or more sensors of the vehicle.

In certain aspects, the first message is a wake up signaling (WUS) message. In certain aspects, the information related to the vehicle comprises at least one of a current location, a previous location, vehicle direction, or estimated number of occupants. In certain aspects, the UE is the vehicle.

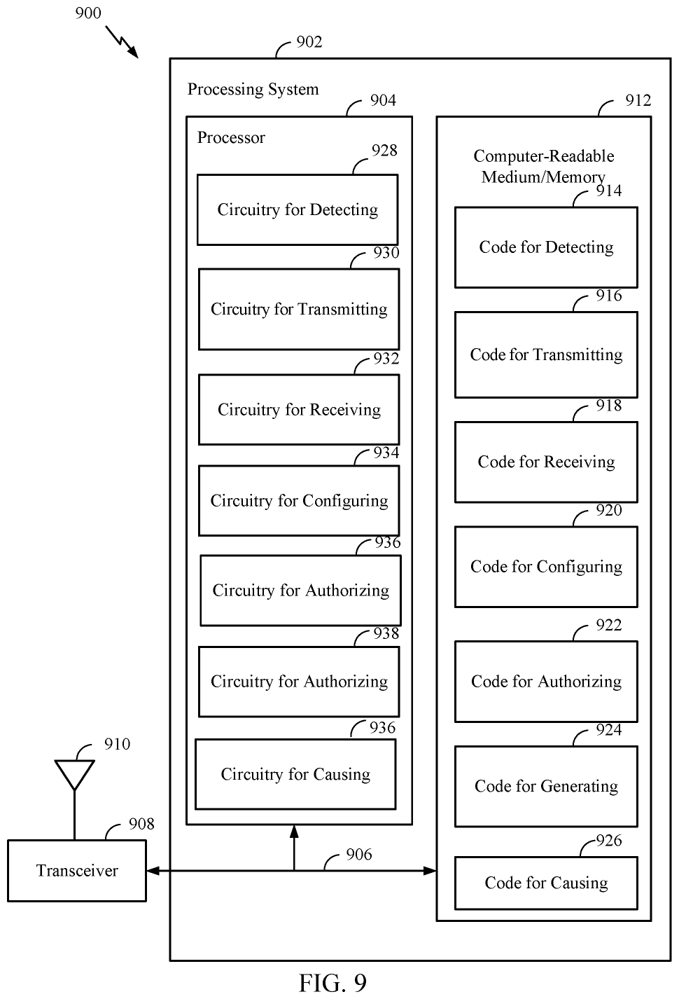

FIG. 9 illustrates a communications device 900 that may include various components (e.g., corresponding to means-plus-function components) configured to perform operations for the techniques disclosed herein, such as the operations illustrated in FIGS. 5 and 8. The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the processor 904 to perform the operations illustrated in FIGS. 5 and 8, or other operations for performing the various techniques discussed herein for licensed wireless in-vehicle network access based on emergency network access control. In certain aspects, computer-readable medium/memory 912 stores code 914 for detecting; code 916 for transmitting; code 918 for receiving; code 920 for configuring; code 922 for authorizing; code 924 for generating; code 926 for causing. In certain aspects, the processor 904 has circuitry configured to implement the code stored in the computer-readable medium/memory 912. The processor 904 includes circuitry 928 for detecting; circuitry 930 for transmitting; circuitry 932 for receiving; circuitry 934 for configuring; circuitry 936 for authorizing; circuitry 938 for generating; circuitry 940 for causing.

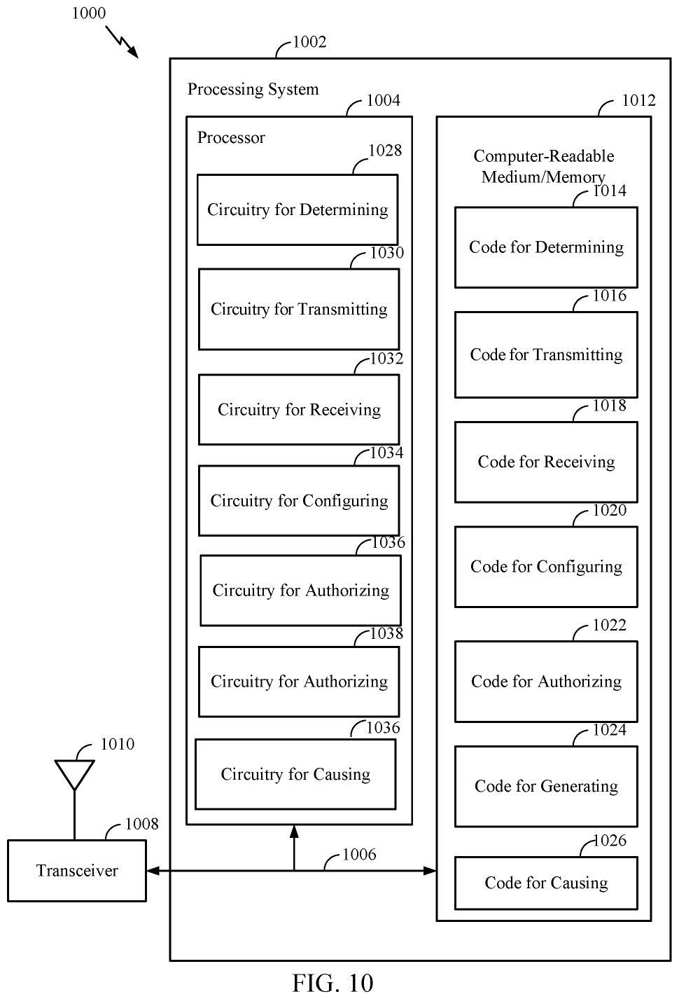

FIG. 10 illustrates a communications device 1000 that may include various components (e.g., corresponding to means-plus-function components) configured to perform operations for the techniques disclosed herein, such as the operations illustrated in FIG. 6. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 6, or other operations for performing the various techniques discussed herein for licensed wireless in-vehicle network access based on emergency network access control. In certain aspects, computer-readable medium/memory 1012 stores code 1014 for determining; code 1016 for transmitting; code 1018 for receiving; code 1020 for configuring; code 1022 for authorizing; code 1024 for generating; code 1026 for causing. In certain aspects, the processor 1004 has circuitry configured to implement the code stored in the computer-readable medium/memory 1012. The processor 1004 includes circuitry 1028 for determining; circuitry 1030 for transmitting; circuitry 1032 for receiving; circuitry 1034 for configuring; circuitry 1036 for authorizing; circuitry 1038 for generating; circuitry 1040 for causing.

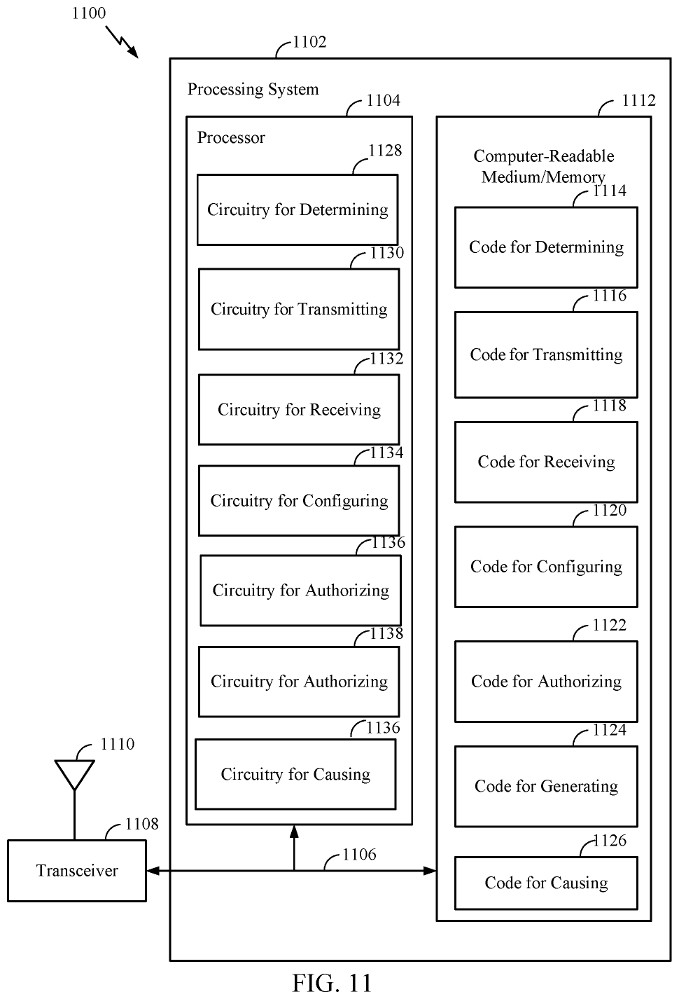

FIG. 11 illustrates a communications device 1100 that may include various components (e.g., corresponding to means-plus-function components) configured to perform operations for the techniques disclosed herein, such as the operations illustrated in FIG. 7. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 7, or other operations for performing the various techniques discussed herein for licensed wireless in-vehicle network access based on emergency network access control. In certain aspects, computer-readable medium/memory 1112 stores code 1114 for determining; code 1116 for transmitting; code 1118 for receiving; code 1120 for configuring; code 1122 for authorizing; code 1124 for generating; code 1126 for causing. In certain aspects, the processor 1104 has circuitry configured to implement the code stored in the computer-readable medium/memory 1112. The processor 1104 includes circuitry 1128 for determining; circuitry 1130 for transmitting; circuitry 1132 for receiving; circuitry 1134 for configuring; circuitry 1136 for authorizing; circuitry 1138 for generating; circuitry 1140 for causing.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 5, FIG. 6, FIG. 7, and/or FIG. 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a user equipment (UE), comprising:
detecting a trigger event for an emergency network access procedure;
in response to detecting the trigger event, transmitting a first message to a base station, the first message comprising a request to use one or more licensed bands for communication via a wireless in-vehicle network (wIVN); and
receiving a second message from the base station, the second message granting the use of the one or more licensed bands for communication via the wIVN by the UE.

2. The method of claim 1, wherein the first message is a radio resource control (RRC) connection request message when the UE is in idle mode.

3. The method of claim 1, wherein the first message is a dedicated radio resource control (RRC) message when the UE is in connected mode.

4. The method of claim 3, wherein the dedicated RRC message is a sidelink UE information (SLUEinfo) message.

5. The method of claim 1, further comprising:
in response to receiving the second message, transmitting a wake up signaling (WUS) message to one or more sensors of a vehicle, the WUS message instructing the one or more sensors to communicate with the UE via the wIVN using the one or more licensed bands.

6. The method of claim 5, wherein the WUS message indicates a configuration of a set of radio resources for communication with the UE.

7. The method of claim 5, further comprising:
receiving, on the one or more licensed bands via the wIVN, one or more messages from the one or more sensors, the one or more messages comprising information related to the vehicle.

8. The method of claim 7, further comprising:
transmitting the received information to a public safety answering point (PSAP).

9. The method of claim 7, wherein transmitting the received information comprises transmitting a Minimum Set of Data (MSD) related to the vehicle.

10. The method of claim 7, wherein the information related to the vehicle comprises one or more of:
a type of the vehicle,
an identifier of the vehicle,
a propulsion type of the vehicle,
a location of the vehicle,
a direction the vehicle, or
a number of occupants of the vehicle.

11. The method of claim 5, wherein the trigger event is an accident involving the vehicle.

12. The method of claim 1, wherein the UE is a vehicle and the trigger event is an accident involving the UE.

13. The method of claim 1, further comprising receiving a system information block (SIB) message from the base station, the SIB message indicating support for the emergency network access procedure by the base station.

14. The method of claim 13, wherein the SIB message or a companion SIB message received by the UE from the base station indicates a configuration of a set of radio resources for communication via the wIVN.

15. The method of claim 13, further comprising:
configuring one or more sensors to communicate with the UE via the wIVN using the one or more licensed bands based on the SIB message.

16. The method of claim 15, wherein the configuring is done via the wIVN.

17. The method of claim 15, wherein the configuring is done via one or more wired connections.

18. A method for wireless communication by a base station, comprising:
receiving a first message from a first UE, the first message comprising a request to use one or more licensed bands for communication via a wireless in-vehicle network (wIVN); and
transmitting a second message to the first UE, the second message granting the use of the one or more licensed bands for communication via the wIVN.

19. The method of claim 18, further comprising:
determining, based on a mode of the first UE, a time duration to use the one or more licensed bands; and
authorizing the use of the one or more licensed bands for the determined time duration by the first UE.

20. The method of claim 19, wherein the time duration is greater when the mode of the first UE is connected than when the mode of the first UE is idle.

21. The method of claim 18, wherein the second message indicates a set of radio resources for communication by the first UE via the wIVN.

22. The method of claim 18, further comprising:
generating, based on an identity of the first UE, a record indicating the use of the one or more licensed bands by the first UE; and
transmitting the record to a network operator.

23. The method of claim 18, wherein the first message is a radio resource control (RRC) connection request message when the UE is in idle mode.

24. The method of claim 18, wherein the first message is a dedicated radio resource control (RRC) message when the UE is in connected mode.

25. The method of claim 24, wherein the dedicated RRC message is a sidelink UE information (SLUEinfo) message.

26. The method of claim 18, further comprising transmitting a system information block (SIB) message to the first UE, the SIB message indicating support for an emergency network access procedure by the base station.

27. The method of claim 26, wherein the SIB message or a companion SIB message transmitted by the base station indicates a configuration of a set of radio resources for communication via the wIVN by the first UE.

28. A method of wireless communication by a sensor of a vehicle, comprising:
receiving a first message from a UE, the first message comprising instructions to communicate with the UE via a wireless in-vehicle network (wIVN) using one or more licensed bands; and
transmitting information related to the vehicle to the UE via the wIVN using the one or more licensed bands.

29. The method of claim 28, wherein the information related to the vehicle comprises at least one of a current location, a previous location, vehicle direction, or estimated number of occupants.

30. The method of claim 28, wherein the first message is a wake up signaling (WUS) message.

31. The method of claim 28, wherein the first message indicates a set of radio resources to use in communication with the communication device via the wIVN.

32. The method of claim 28, wherein the first message indicates a configuration index value corresponding to a predetermined emergency network access configuration of the sensor.

33. A method of wireless communication by a user equipment (UE), comprising:
transmitting a first message to one or more sensors of a vehicle, the first message instructing the one or more sensors to communicate with the UE via a wireless in-vehicle network (wIVN) using one or more licensed bands;
receiving, on the one or more licensed bands via the wIVN, a second message from a first sensor of the one or more sensors, the second message comprising information related to a vehicle; and
transmitting the received information to a public safety answering point (PSAP).

34. The method of claim 33, further comprising:
receiving a system information block (SIB) message from a base station, the SIB message comprising a configuration of a set of radio resources for communication via the wIVN; and
causing the one or more sensors to reconfigure based on the received configuration of the set of radio resources.

35. The method of claim 34, further comprising:
transmitting a third message to a base station, the third message comprising, based on the received configuration of the set of radio resources, a request to use the one or more licensed bands for communication via the wIVN;
receiving authorization from the base station to use the one or more licensed bands and allocation of the set of resources for communication via the wIVN; and
in response to receiving the authorization, transmitting the first message to the one or more sensors of the vehicle.

36. The method of claim 33, wherein the first message is a wake up signaling (WUS) message.

37. The method of claim 33, wherein the information related to the vehicle comprises at least one of a current location, a previous location, vehicle direction, or estimated number of occupants.

38. The method of claim 33, wherein the UE is the vehicle.

39. A user equipment (UE) comprising:
a memory; and
a processor coupled to the memory wherein the memory and the processor are configured to perform the method of one or more of claims 1-17.

40. A user equipment (UE) comprising:
various means for performing the method of one or more of claims 1-17.

41. A non-transitory computer-readable medium including instructions that when executed by a user equipment (UE), cause the UE to perform the method of one or more of claims 1-17.

42. A base station (B S) comprising:
a memory; and
a processor coupled to the memory wherein the memory and the processor are configured to perform the method of one or more of claims 18-27.

43. A base station (B S) comprising:
various means for performing the method of one or more of claims 18-27.

44. A non-transitory computer-readable medium including instructions that when executed by a base station (B S), cause the BS to perform the method of one or more of claims 18-27.

45. A sensor comprising:
a memory; and
a processor coupled to the memory wherein the memory and the processor are configured to perform the method of one or more of claims 28-32.

46. A sensor comprising:
various means for performing the method of one or more of claims 28-32.

47. A non-transitory computer-readable medium including instructions that when executed by a sensor, cause the sensor to perform the method of one or more of claims 28-32.

48. A user equipment (UE) comprising:
a memory; and
a processor coupled to the memory wherein the memory and the processor are configured to perform the method of one or more of claims 33-38.

49. A user equipment (UE) comprising:
various means for performing the method of one or more of claims 33-38.

50. A non-transitory computer-readable medium including instructions that when executed by a user equipment (UE), cause the UE to perform the method of one or more of claims 33-38.
